(19) United States
(12) Patent Application Publication
(10) Pub. No.: US 2019/0231501 A1
(43) Pub. Date: Aug. 1, 2019

(54) EQUINE SPECULUM

(71) Applicant: Liam Kelly, Midland Park, NJ (US)

(72) Inventor: Liam Kelly, Midland Park, NJ (US)

(21) Appl. No.: 16/265,276

(22) Filed: Feb. 1, 2019

Related U.S. Application Data
(60) Provisional application No. 62/625,338, filed on Feb. 1, 2018.

(51) Int. Cl. A61D 15/00; A61D 5/00

(52) U.S. Cl. CPC A61D 15/00; A61D 5/00

(57) ABSTRACT

A speculum tool that adds a lower strap at a point that does not interfere with the with the movement of the jaws of the speculum. The lower strap provides a low point of attachment for the tool. Until now, equine speculums were tethered by the upper strap, with the tether secured onto an immobile structure, such as a wall of a barn. The rear strap would then be looping behind the ears of the patient and back to the opposite side of the speculum's upper jaw. In this way the upper strap provided an overhead attachment that elevated the animal's head during procedure, while the ear strap provided a lower attachment to keep the speculum from slipping off the head and to keep the upper strap from raising the head of an animal too high. The present invention adds additional low point attachment to an already improved rear strap for additional tethering security and as an additional factor in minimizing the risks of harming eyesight and spinal cords of equine patients.

### CLAIM OF PRIORITY

This application claims prior of the U.S. Provisional Patent Application No. 62/625,338 filed on Feb. 1, 2018, the contents of which are fully incorporated herein by reference.

### FIELD OF THE INVENTION

The present invention relates to equine medical care, in particular to a tool helpful in equine dental examinations and dental procedures.

### BACKGROUND OF THE INVENTION

A speculum is a tool for retaining an orifice in an open position, so that a physician or a medical professional can carry out an examination or procedure. In the instant case, a speculum is designed to retain a mouth of an animal, in particular, a horse, ajar, so that a dental technician or a veterinarian is able to examine the animal's teeth or carry out dental sculpting procedures and extractions.

An equine speculum has been in use for some time but suffered from several significant drawbacks that forced practitioners to utilize alternative techniques and tools. The primary drawback of an equine speculums available in the prior art, is lack of control of the animal's head while a procedure is in progress. This lack of control translates into a higher risk of an injury to the animal in the event of a sudden jerk or rearing during the procedure. The increased risk is primarily due to the elevated position of the head, which strains the neck vertebrae, and because in an elevated position, the back strap of existing speculums, which must necessarily wrap behind animals' ears, would be at the same level as the animal's eyes, thus putting the animal at risk of eye injury or even blindness.

The present invention intends to solve the problems that existed with prior art:

First—the attachment of the back strap at the rear portion of the speculum has been placed on a member of the frame that extends the frame further along the cheeks and beneath the eyes, such that when the device is in position, the back strap cannot get elevated to a degree that it comes into contact with the eyes.

Second—the extended element of the frame provides a point of attachment for a lower strap at a point that does not interfere with the with the movement of the jaws of the speculum. The lower strap provides a low point of attachment for the tool. Until now, equine speculums were only tethered using an upper strap, with the tether secured onto an immobile structure such as a wall of a barn. The rear strap would then loop behind the ears of the horse, attaching to the opposite side of the speculum's upper jaw. In this way the upper strap provided an overhead attachment that elevated the animal's head during a procedure, while the ear strap provided a lower attachment to keep the speculum from slipping off the head and to keep the upper strap from raising the head of an animal too high. But the lack of a lower strap strained the animal's neck and frequently forced the back strap to be elevated over the animal's eyes. The present invention adds additional lowest point of attachment to an already improved rear strap to further improve tethering configuration and as an additional factor in minimizing the risks of harming eyesight and spinal cords of equine patients.

A third novel and non-obvious improvement to the speculum tool discloses a new bite plate that accommodates jaws more naturally, to further decrease stress on the animal. It is preferred that materials used for the removable bite plate have soft but durable characteristics to give horses a better and healthier experience during a procedure. The removable nature of the bite plate gives an opportunity for the technician to remove the bite plate for cleaning, or to insert a bite plate having a different size or shape.

### BRIEF DESCRIPTION OF THE DRAWINGS

FIG. 1 is a speculum device in use.

FIG. 2 is a perspective view of the equine speculum.

FIG. 3 is a rear view of the speculum, demonstrating the novel attachment of the lower and rear straps.

FIG. 4 is a view of the bite plates of the speculum.

FIG. 5 is a close-up view of the pivot handle of the speculum.

FIG. 6 is a sideview of the bite plate.

FIGS. 7 and 8 additional views of the speculum and removable bite plate insert.

### SUMMARY OF THE INVENTION

The present invention is comprised of a first upright brace forming an upper jaw and a second upright brace forming a lower jaw. The first upright brace is mounted just below the upper lip of a horse, wrapping around the teeth from one side of the head to the other. After accommodating the upper teach on a bite plate, the first upright brace arches upward and then sweeps downward to connect with the distal ends of the second upright brace. The distal ends of the first upright brace connect to the lever arms of a handle. The second upright brace is mounted over the lower jaw and lower lip of the horse. The second upright brace wraps around the lower lip from one side to the other. Immediately after accommodating the lower front teeth on a bite plate, the second upright brace arches downward and then sweeps upward. Each arm of the second upright brace connects to the distal ends of the lever arms of the handle, with the distal ends of the lower brace pivotedly connecting to the rearmost point of the arch of the first upright brace. The pivotal connection between the first and second upright braces rotates the braces open and shut with respect to one another. The lever arms are pivotedly connected to the first and second braces to control to opening distance between the upper and lower bite plates, which controls the degree to which the horse's mouth is open, during the procedure. Since speculum is intended to expose the molars, the front teeth are used to support horse's jaws without impacting the soft tissues of gums and lips.

Level with the pivoted connection between first and second brace is the protruding member, which extends towards the rear of the horse's head when the device is mounted. The protruding member supports two straps, the back strap, which loops behind the horses ears and ensures that the device does not fall out when mounted on a horse, and a lower strap, which counteracts the upward pull of the upper strap. These three straps, upper, back and lower, hold the device in place and secure the device against a structural element, such as a ring in a beam, floor or wall of the physical location where the teeth maintenance procedure takes place.

The opening of the mouth is maintained at an intended distance using a terminal bar. The terminal bar descends vertically downward from the front point of the second upright brace and contains a plurality of openings. The openings accept a spring-loaded pressure pin that is located between the lever arms of the handle.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

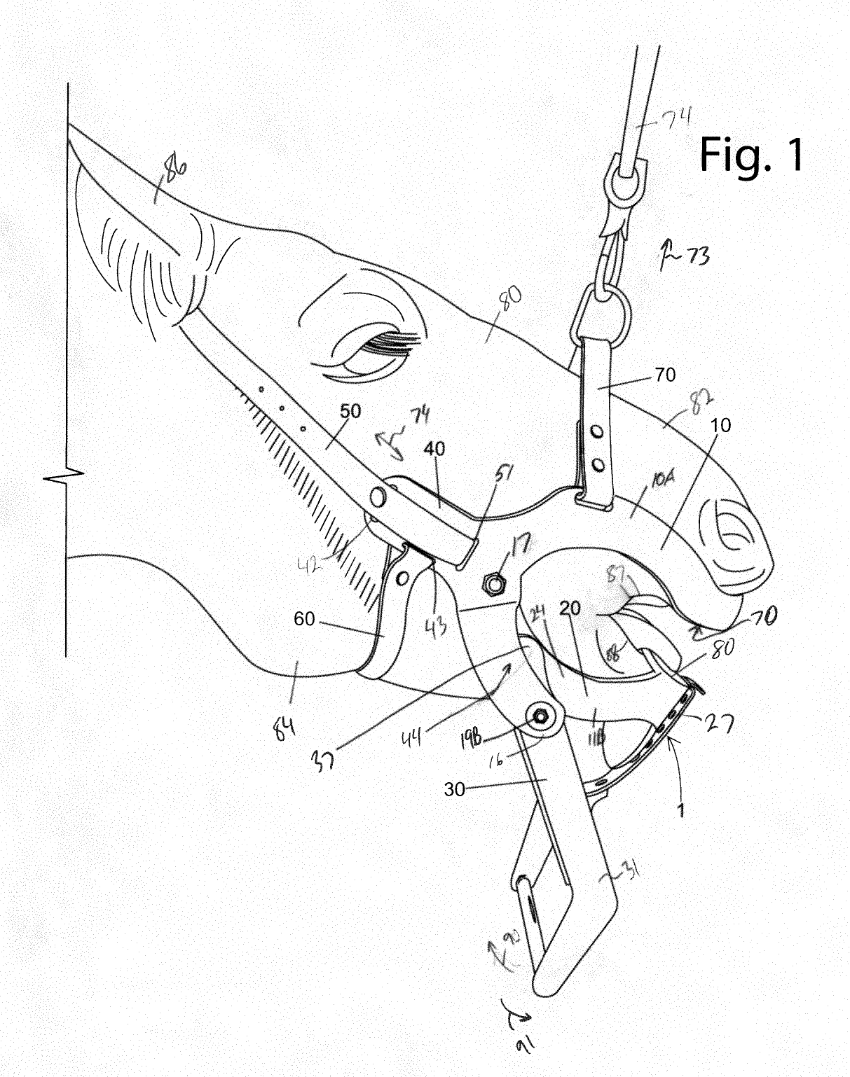

FIG. 1 demonstrates the head of the horse 80. The upper strap 73 connects to a tether 74. The opposite end of the tether 74 connects to some immobile structural element. To ensure that the horse will not back up or walk away during a dental procedure. The back of the speculum 1 is connected using a band 50 which loops around the ears 86. The lower strap 60 loops below and around the lower jaw between two parallel protruding members 40 on either side of the horse's head. The lower strap 60 is mounted immediately ahead of the cheek 84. Also shown is the lower bite plate 80 and upper bite plate 71. Adjacent to the bite plate 71 in an arching section 10A and adjacent to the lower bit plate 80 is the parallel arching section 11A.

The control lever 30 moves in a downward direction 90 to move the upper and lower jaws 10 and 20, respectively closer together. Moving the control lever 30 in an upward direction 91 moves the jaws 10 and 20 further apart. The first pivot 10A connects the first upright brace 14 and the second upright brace 24. The pivoted connections 19B connects the parallel lever arms 31 with the distal end 16 of the first upright brace 14. The distal end 37 of each parallel lever arm is within the pivotal connection 44 between the distal end 37 and the lower jaw 20. The pivotal connection 44 serves as an anchor for enabling the rotation of the upper jaw 10.

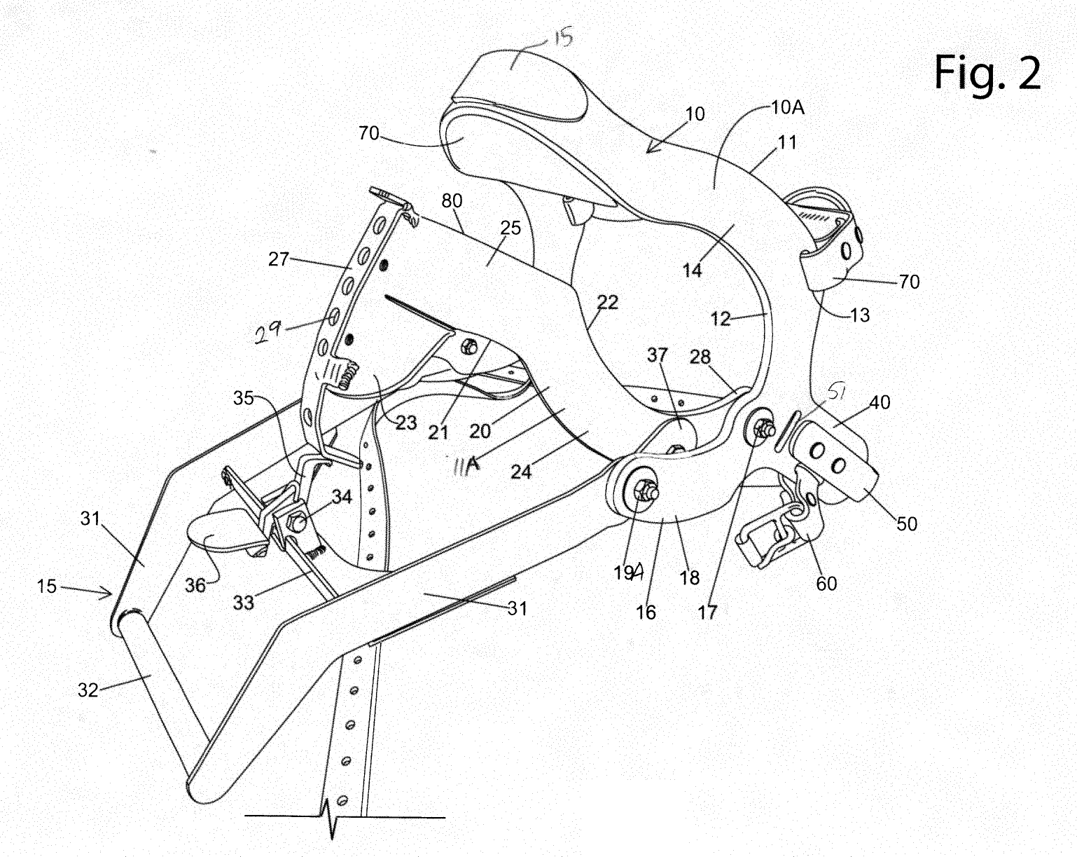

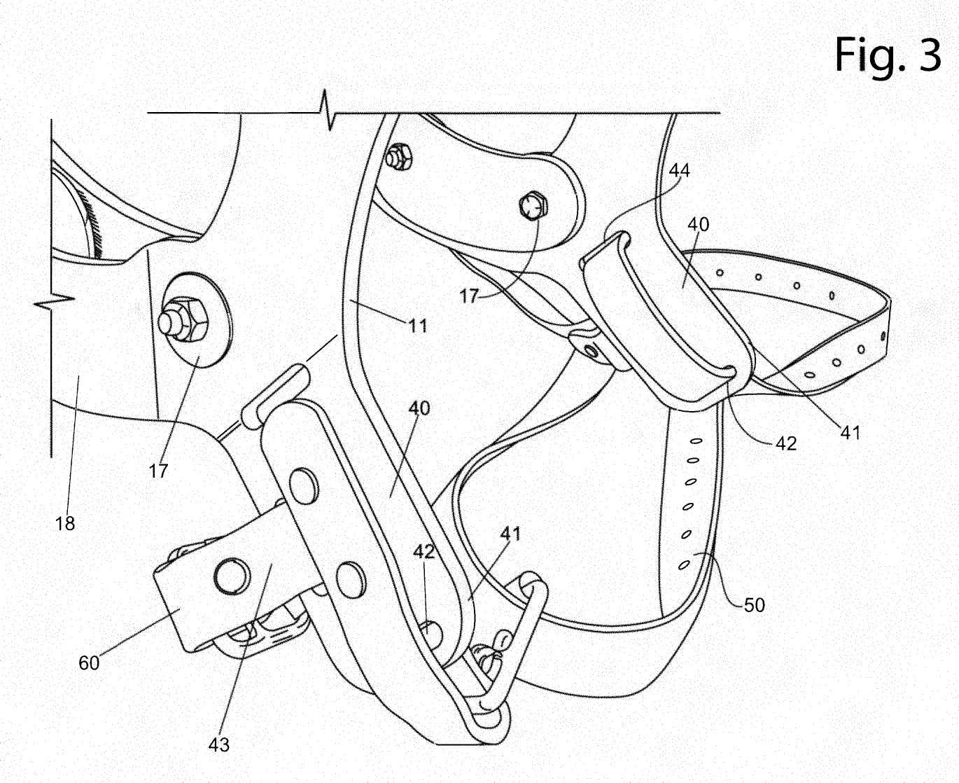

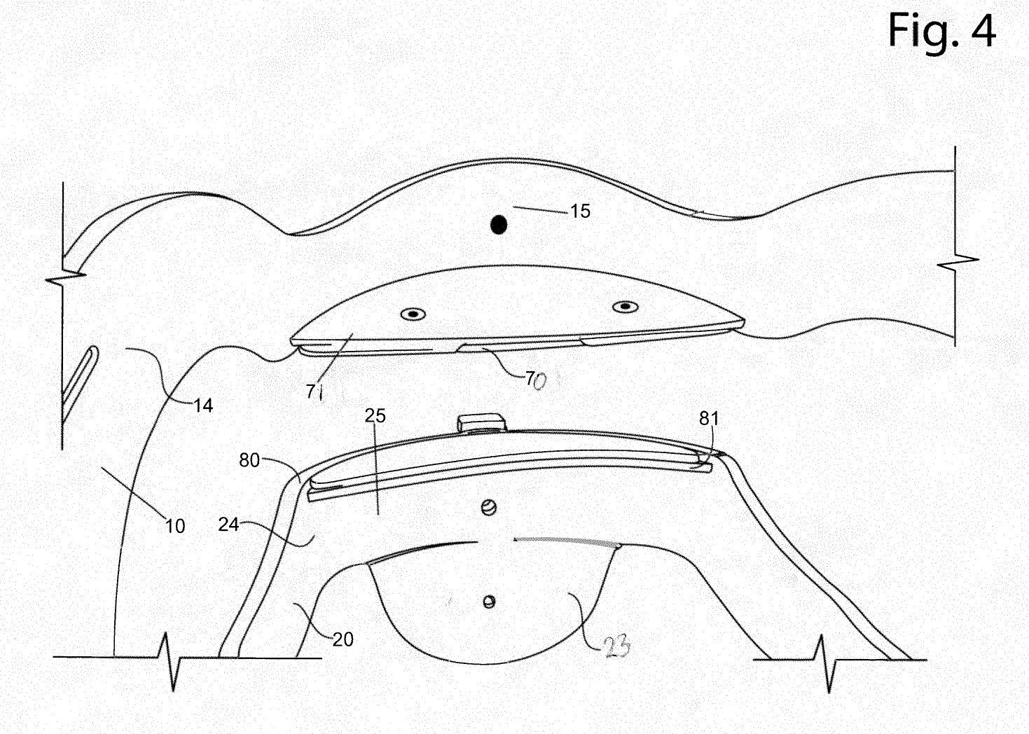

Now referring to the FIGS. 2-5, the present invention is an equine speculum 1 comprising an upper jaw 10, a lower jaw 20 and a control lever 30. The upper jaw 10 is composed of a first upright brace 14, where the front portion 15 of the first upright brace 14 forms a band around an upper bite plate 71. Immediately adjacent to the front section 15 are two parallel curved sections 10A. Each curved section 10A curves slightly upward and then downward in a circular pattern. Along the point of the upwardly curved section is slot 13 for insertion of an upper belt or strap 70. The upper belt 70 is designed to go over the snout of the animal to the analogous slot 13 of the upwardly curved portion of the parallel curved section 10A. Along the inner edge 12 of each curved section 10A of the first upright brace 14, approximately at middle point of said curved section 10A is a pivot 17 that joins the first upright brace 14, with a distal end 28 of the second upright brace 24 that forms the lower jaw 20 of the disclosed device 1.

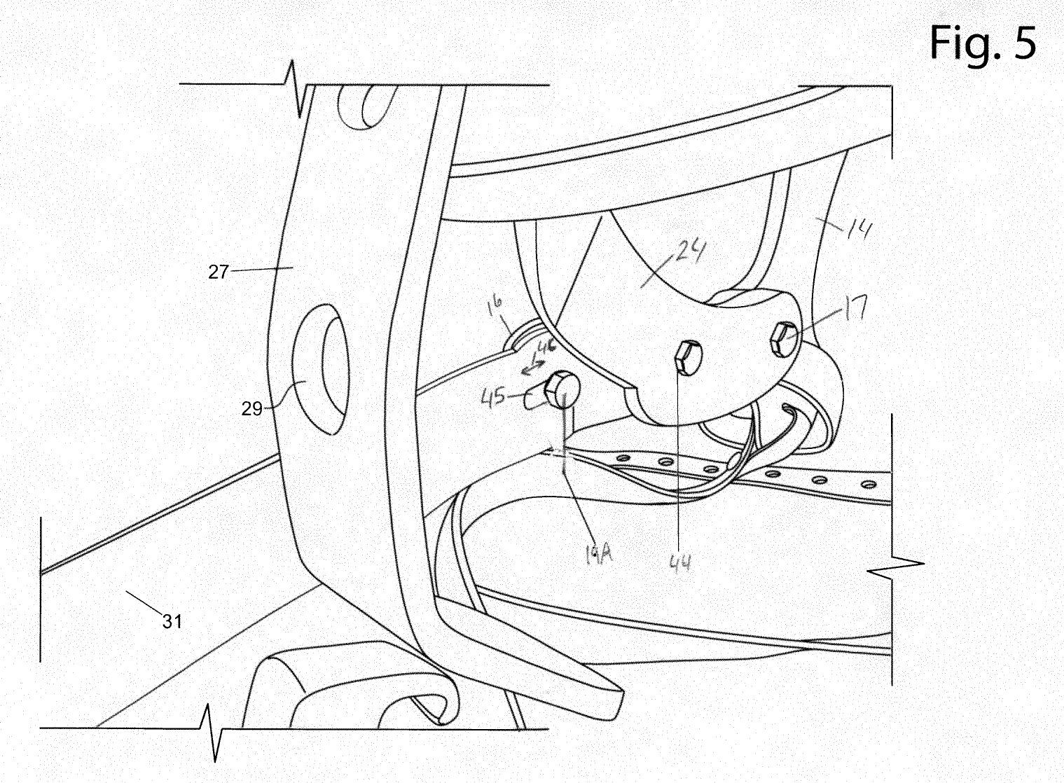

Each distal end 16 of the first upright brace 14 (these distal ends 16 are parallel to each other) connects to a slot 45 on the control lever arms 31. The pivoted connections, as demonstrated in a close-up resolution on FIG. 5, as shown as the pivot 17 between the upper jaw 10 and lower jaw 20; the anchoring pivot 44 between the distal end 37 of the lever arm 31 and the second upright brace 24; and the pivotal connection 19A between the distal end 16 and the lever arm 31. The pivotal connection 19A oscillates in the direction 46 within the slot 45. The slot 45 is necessary since the rotation of the first upright brace 14 and second upright brace 24 forces the point of intersection between the distal end 16 and the lever arm 31 to vary slightly during rotation. Without the slot 45, the clamping motion of the jaws 10 and 20 would be severely restricted. It should be appreciated that FIG. 5 shows only one side of the device 1, the same exact configuration, and parallel to the one just described, exists on the other side of the device 1.

Substantially level with the pivot 17, but along the outer edge 11 of each curved section 10A is a protruding member 40. The protruding member 40 extends between three and six inches, so that when the device is in place, the distal end 41 is on the same horizontal plain as the eye of the horse, or even extending over the cheek 84. The length of the protruding member 40 may be adjustable. Protruding members 40 are parallel to each other on each side of the first upright brace 14.

The protruding member 40 preferably contains two slots. The first slot 42 is at its distal end 41 and the second slot 43 is along the length of said protruding member 40. An additional slot 51 may exist at the base of the protruding member 40. The first slot 42 is used for a rear belt 50 or band which is wrapped behind the ears of the animal. The second slot 43 is for the bottom band 60 which loops beneath the lower jaw of the animal patient to an opposite but parallel slot 43. This positioning of the rear belt 50 and the bottom belt 60 ensure that the upper strap 70 does not drag the back strap 50 over the eyes of the horse and further ensure that the elevation the strap 70 does not excessively strain the neck of the horse, since the lower belt 60 provides a support that the horse may use to pull down on the tether 74 to counteract the upward force 73. Alternatively, the rear and bottom belts, 50 and 60 respectively, may utilize a single slot along the length of the protruding member 40.

The lower jaw 20 is composed of a second upright brace 24. The front section 25 of the second upright brace 24 curves around a lower bite plate 80 and forms a border around the bight plate 80. Immediately adjacent to the front section 25 are two parallel curved sections 11A, which arch slightly downward and then upward in a circular pattern. Distal ends 37 of each lever arm 31 of the control lever 30 are pivotedly and parallelly connected along each curved section 11A. Each distal end 28 is then pivotedly connected via the pivot 17 to the upper jaw 10.

Each curved section 10A of the first upright brace 14 flares outwardly 18 to permit insertion of the control lever arms 31. The control lever 30 further contains the handle 32 that spans two lever arms 31. The distal end 37 of each lever arm 31 is pivotedly attached along a curved section of the second upright brace 11A. Behind said point and/or substantially adjacent to the connection at point 37, is a pivotal attachment 19A to the second upright brace 14 through a pivot 19A, which is inserted into a slot 45 admitting a pivotal attachment 19A to a distal end 16 of a curved section 10A of the first upright brace 14. In this configuration, pulling the handle 32 of the lever 30 upward towards the lower bite plate pushes the upper jaw 10 upward, expanding the mouth opening of the animal patient, while pulling the handle 32 downward, away from the lower bite plate 80, brings the upper bite 71 plate closer to the lower bite plate 80, thus closing the mouth of an animal patient.

The lever arms 31 are also joined by a bracket 33 attached along the length of the lever arms 31. The bracket 33 contains a seesawing pressure pin 34. The end of the pressure pin 34 closest to the handle 32 is in the form of a paddle 36. The paddle 36 serves as a lever to retract and release the pressure pin 34. The lever 30 may be operated single-handedly or using both hands depressing or releasing the paddle 36. The opposite end of the pressure pin 34 contains the pin 35. The point of attachment of the pressure pin 34 to the bracket 33 is spring-loaded with the pin 35, which is biased to tilt in the direction of the lower jaw 20 so as to enter the plurality of openings 29 designed to immobilize the jaws 10 and 20 at a certain distance of separation from one another. Substantially adjacent to the connection of lever arm 31 and second upright brace 14 is a slot 45 that is used to pivotedly connect each distal end 16 of the first upright brace 14.

Corresponding to the pressure pin 35, is a terminal bar 27 running vertically along the front 25 of the lower support brace 24. The terminal bar 27 contains a plurality of equidistant openings 29 that serve as terminals of the pressure pin 35. The pressure pin 35 and the terminal bar 27 are used to preserve a desired distance between lower and upper bite plates 80 and 71 respectively. The bottom portion of the terminal bar 27 is supported by the lower support brace extension 23.

The upper bite plate 70 and the lower bite plate 80 press against the front, or the incisor teeth of an animal patient. The surface area of the upper and lower bite plates 70 and 80 are covered with upper and lower inserts 71 and 81 respectively. Furthermore, it is preferred that the thickness of the upper and lower inserts 71 and 81 is the greatest near the upper support brace 14 or lower support brace 24, respectively, with a gradual decrease from the thickest area until the edge 72 of the upper and lower bite plates 70 and 80. The purpose of the variable thickness is to accommodate the natural bite of a horse. The inserts 71/81 are preferably made from durable but soft material, such as plastic and resin. The inserts 71/81 may be removable if a different material or a different thickness is desired.

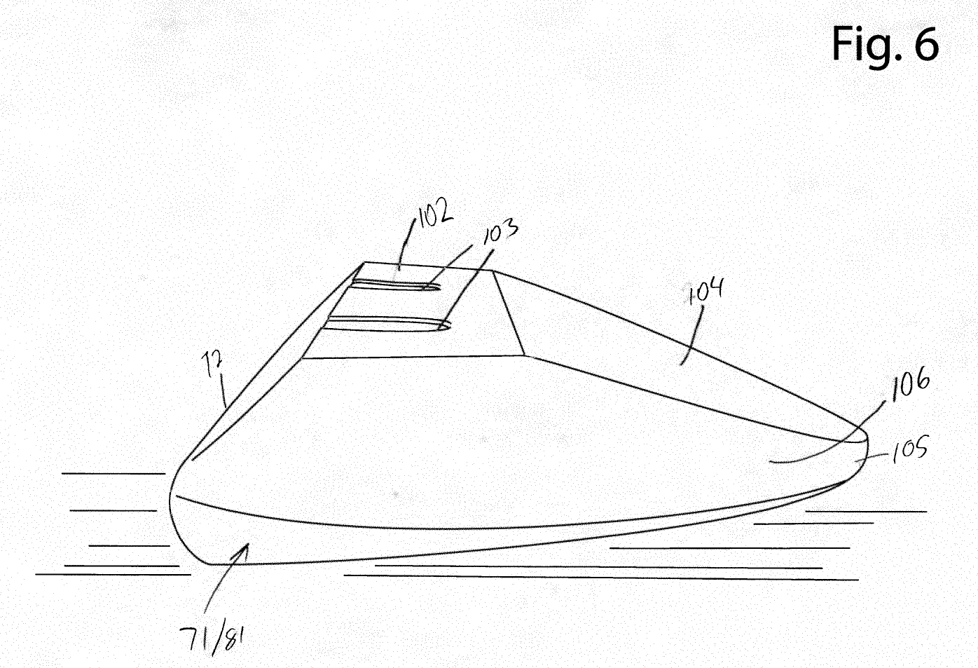

FIG. 6 demonstrates a sideways perspective view of the bite plate insert (which is item 71 for the upper bite plate 70 and item 81 for the lower bite plate 90). The bite plate insert 71 comprises the incisor plate 104, which is angled down with the front point 105 corresponding with the front section 15 or 25 of the first or second upright braces 14 or 24, respectively. The incisor teeth are usually slight flared outwards, therefore an angled surface 104 provides ample support without undesired pressure of a flat surface in the same area. The edge 72 in the back of the fastening section 102 is angled as well, to present an obtuse or blunt surface to the tongue of the animal. The fastener openings 103 may accommodate screws, snaps or magnets. The angle of the incisor plate 104 may be changed and the overall size and thickness of the base plate insert may vary to accommodate different mouth sizes.

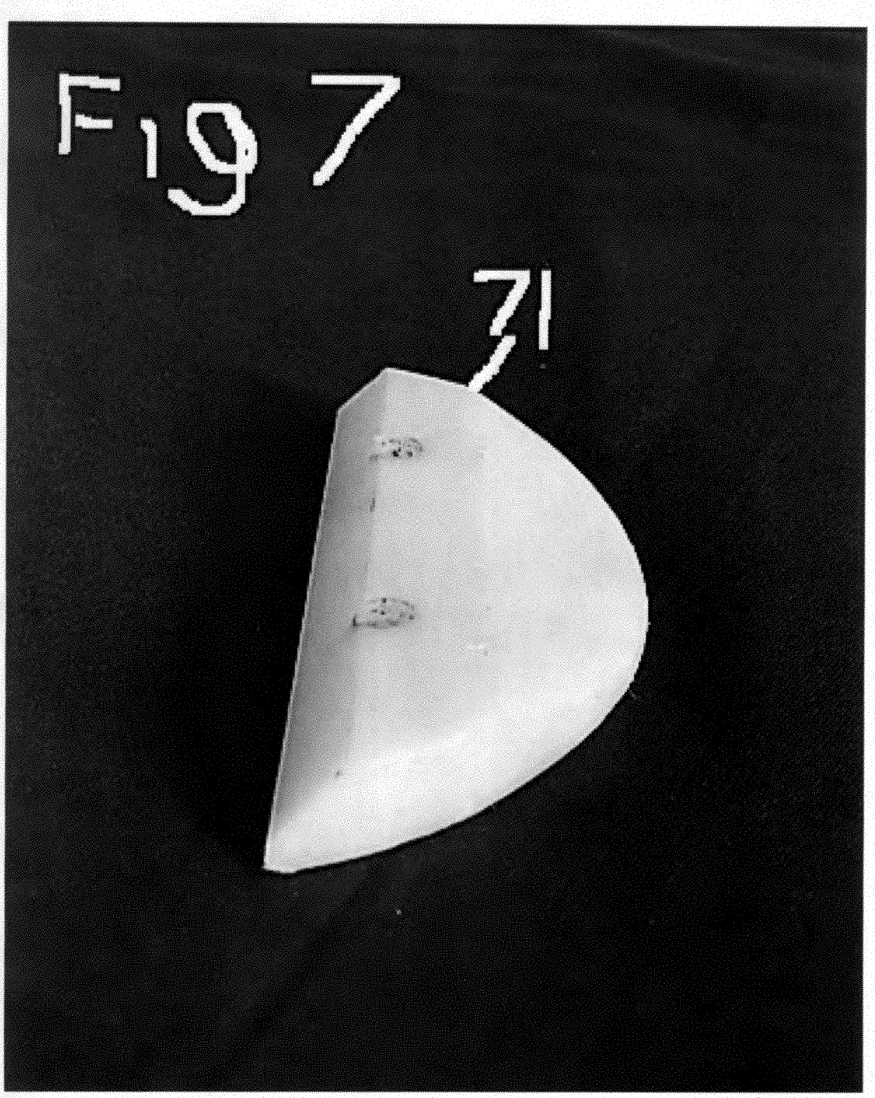

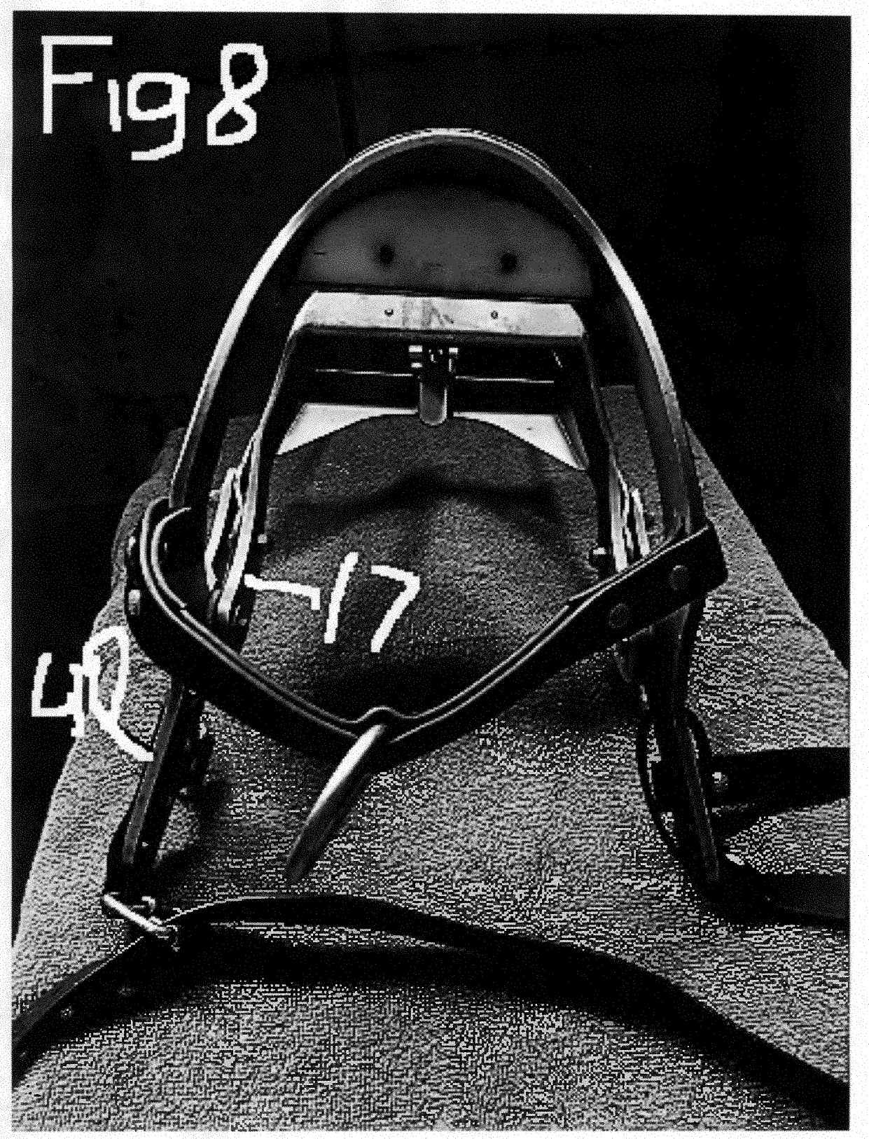

FIG. 7 is another angle of the bite plate insert 71. FIG. 8 shows the back view of the device 1, demonstrating the parallelism of the protruding members 40 and the pivot 17 among others.

Although this invention has been described with a certain degree of particularity, it is to be understood that the present disclosure has been made only by way of illustration and that numerous changes in the details of construction and arrangement of parts may be resorted to without departing from the spirit and the scope of the invention

What is claimed:

1. A speculum device comprising: an upper jaw, a lower jaw, and a lever; wherein said upper jaw is pivotedly connected to said upper jaw; wherein said lever comprises at least one lever arm, said at least one lever arm pivotedly connected to said upper and lower jaws such that an upward or a downward motion of said lever causes the front portions of said upper and lower jaws to come closer together or move further apart from one another; at least two protruding members, each of said two protruding members being in parallel to each other and disposed along an outer edge and substantially to the rear of said upper jaw, said at least two protruding members having openings for a back strap and a bottom strap, said back strap capable of looping around an animal's ears while simultaneously being attached to said parallelly protruding members, and said bottom looping below a jaw bone from one of said two protruding member to said other of said two protruding members; and an upper band disposed along the length of said upper jaw, said upper band looping over a snout of a horse.

2. The speculum device of claim 1, further comprising a terminal bar along a front of said lower jaw, said terminal bar having a plurality of opening to admit a pressure pin installed on said lever, wherein said pressure pin immobilizing said upper jaw and said lower jaw at a desired distance from each other.

3. A speculum device comprising, a first upright brace forming an upper jaw and a second upright brace forming a lower jaw; said first upright brace to be mounted just below an upper lip of a horse and wrapping around incision teeth of said horse from one side of a head to a second side of said head; a bite plate disposed in the front portion of said first upright brace; adjacent to said bite plate, in parallel arching sections of the first upright brace, arching upward and then sweeping downward to connect with a distal ends of a second upright brace; distal ends of the first upright brace connecting to lever arms of a handle; a second upright brace to be mounted over a lower jaw and a lower lip of said horse; said second upright brace wrapping around said lower lip from one side of said head to another side of said head; a lower bite plate disposed in a front portion of said second upright brace; adjacent to said bite plate, in parallel an arching section of the second upright brace, said arching section arching downward and then sweeping upward, each said arching section of said second brace terminating in a distal end, wherein said distal end pivotedly connecting along said arching section of said first upright brace; wherein each arching section of the second upright brace connecting to the distal ends of lever arms of a handle; said pivotal connection between the first and second upright braces rotating said first and second upright braces in a clamping motion with respect to one another; wherein said lever arms are pivotedly connected to the first and second braces; a protruding member disposed at the rear of each arching section of said first upright brace; said protruding member having a back strap connecting said protruding member with a protruding member of parallel arch of said first upright brace; and said protruding member having a lower strap spanning said protruding member and a protruding member of said parallel arching second of said first upright brace.

4. The speculum device of claim 3, wherein said bite plate of said upper and said lower upright braces further comprising a removal bite plate insert; wherein an incisor plate of said bite plate insert angled in to accommodate incisor teeth.

5. The speculum device of claim 4, wherein said incisor plate being angled at various degrees.

6. The speculum device of claim 4, further comprising a back edge being blunted to accommodate a tongue of an animal.
